(19) United States
(12) Patent Application Publication
(10) Pub. No.: US 2009/0282164 A1
(43) Pub. Date: Nov. 12, 2009

(54) Method, Communication System, Multimedia Nodes, and Gateway for Transmitting Multimedia Data in MPEG Format

(76) Inventors: Thomas Fuehrer, Gerlingen (DE); Martin Piastowski, Schwieberdingen (DE)

Correspondence Address: KENYON & KENYON LLP, ONE BROADWAY, NEW YORK, NY, 10004, US

(21) Appl. No.: 12/086,543

(22) PCT Filed: Dec. 11, 2006
(86) PCT No.: PCT/EP2006/069548

§ 371 Date: Mar. 17, 2009

(30) Foreign Application Priority Data
Dec. 12, 2005 (DE) 102005059616.9

(51) Int. Cl. G06F 15/16

(52) U.S. Cl. 709/236

(57) ABSTRACT

A method for transmitting multimedia data in MPEG format between multimedia nodes of a communication system via at least one communication link of the communication system. To configure the transmission of the multimedia data in the most efficient possible manner and to reduce the number of different communication systems in a vehicle, the MPEG multimedia data is transmitted via a FlexRay communication system according to the FlexRay protocol. For this purpose, the size of the payload segments of FlexRay data frames may be adjusted to the size of the MPEG data frames. The payload segment of a FlexRay data frame may be selected to be of the same size as the MPEG data frame, in particular 188 bytes long.

### RELATED APPLICATION INFORMATION

The present application is a United States national phase patent application and claims the benefit of and priority to International Application No. PCT/EP2006/069548, which was filed Dec. 11, 2006, and which claims the benefit of and priority to German Patent Application No. 10 2005 059 616.9, which was filed in Germany on Dec. 12, 2005, both of which are incorporated by reference.

### FIELD OF THE INVENTION

The present invention relates to a method for transmitting multimedia data in MPEG (Moving Picture Experts Group) format. The present invention also relates to a communication system for transmitting multimedia data in MPEG format. The present invention also relates to a multimedia node of a communication system for transmitting multimedia data in MPEG format. The node may be a multimedia source or a multimedia receiver. Finally, the present invention also relates to a gateway for connecting a multimedia node to a communication system for transmitting multimedia data in MPEG format.

### BACKGROUND INFORMATION

Different vehicle networks and network architectures are known from the related art. They are usually distinguished by their application domains which are based on different requirements for data rates, packet sizes, latency times, and transmission jitter (fluctuations in the transmission time) in the communication systems. The application areas of the multimedia components are subdivided into system electronics, body electronics, and consumer electronics. The system electronics is subdivided into so-called “fail operational” (after a component failure the functionality is fully preserved) and “fail safe” (after a component failure operation continues in limp-home mode without affecting the other components). The body electronics includes only so-called “fail safe” components. A gateway (network transition, interface) is situated between the “fail operational” components and the “fail safe” components of the system electronics as well as between the “fail safe” components of the system electronics and the “fail safe” components of the body electronics. A firewall (access protection system) is situated between the components of the body electronics and those of the consumer electronics. The components of the system electronics and the body electronics are covered mainly by a CAN (Controller Area Network). In the area of the body electronics, bus systems such as LIN (Local Interconnected Network) have also been established as sub-buses.

In the past few years, the multimedia equipment of motor vehicles has developed from a simple radio, occasionally including a cassette player or a CD drive, into a plurality of sophisticated and highly developed information systems, which must communicate and interact among each other and, of course, with the users. Today's motor vehicles have GPS navigation systems which may operate in conjunction with a security system to ascertain the location of a stolen vehicle. The safety of the occupants makes it necessary that the driver concentrates on controlling the vehicle, rather than on the details of the individual components. A car phone must interact with the audio device to reduce the sound volume when a call is made. Voice control and a hands-free device require a microphone which records and digitizes the voice. Display systems are required for outputting navigation information, DVD playback, and reproduction of TV pictures.

All these multimedia components must be operated through a driver interface. Sound and image information must be output in a large selection of formats to inform the driver and/or to entertain the passengers. Since information comes from different sources, the components must be capable of managing and processing information in order to be capable of reliably outputting it to the user.

For the components of the consumer electronics, in particular for transmitting multimedia data, direct wiring and MOST networks have currently been established. The use of Firewire as a multimedia bus is also being considered. In the area of consumer electronics, the demands on bandwidth are extremely high. MOST is a multimedia fiber optic network which is optimized for automotive applications. The MOST bus makes it possible to develop the components independently of each other and then to interconnect them using standard hardware and/or software interfaces, ensuring digital interoperability. Additional components and functions may be easily appended, since the MOST network makes the infrastructure available for information transmission from one component to another. Motor vehicles are also individually adapted by the dealership to the wishes of the buyer, rather than being selectable from a predefinable list. Safety is enhanced because the multimedia components have defined interfaces for interacting with each other and may be operated in a simple manner via user interfaces.

The MOST bus supports data rates from 5.76 Mbit/s to 24 Mbit/s. A parameter set enabling 21.17 Mbit/s has been established. The MOST standardization goes back to an initiative from 1997, when the only digital data source commonly used was the audio CD. Therefore, designing the MOST data structure in such a way as to enable the transmission of CD audio channels using the MOST network was the obvious thing to do. Each block of the MOST frame structure therefore includes 16 data frames. Each frame must contain synchronous data; it may, however, also additionally contain asynchronous data. A maximum of 60 bytes per frame may be transmitted to synchronous data which include audio and video streams. At a frame repetition rate of 44.1 kHz, which corresponds to the CD sampling rate, a data rate compatible with the audio CD results (when using three of the maximum of 16 logic channels transmitted by the time-multiplex method). While this frame format is optimal for audio CDs, it is poorly suited for today's video data streams, for example, in MPEG (Moving Picture Experts Group) format.

Current multimedia systems are based on MPEG. MPEG defines the way digital audio and video data may be efficiently transported in a data steam. The main areas of application are DVD (Digital Versatile Disk) and digital TV (DVB—Digital Video Broadcasting in Europe; ISDB—Integrated Services Digital Broadcasting in Japan; and ATSC—Advanced Television Systems Committee in the USA). The MPEG transport stream is based on 188 byte long data frames. Each MPEG frame has a four-byte header. For example, an MPEG2 transport stream has a sequence of multiple MPEG data frames. It is characterized by a continuous data stream.

When using direct wiring between the multimedia components, a highly complex wiring results. The use of a plurality of different bus systems in a certain environment (motor vehicles, machines, etc.) also results in highly complex wiring. The mass production effects (low costs, sturdy and reliable manufacture) are limited because different components are needed for each bus system, for example, CAN protocol modules having corresponding driver components vs. MOST components having specific driver components. In addition, the transport of an MPEG data stream over a MOST bus system requires additional complexity and system resources because the MOST and MPEG data frame formats are incompatible.

Interconnection of control units, sensors, and actuators using a communication system or data transmission system and a communication link, for example, in the form of a bus system, has drastically increased in the past few years in modern motor vehicles, but also in other areas such as mechanical engineering, in the machine tool industry in particular, as well as in automation. Synergetic effects as a result of the distribution of functions to a plurality of nodes, for example, control units of the communication system, may thus be achieved. This is known as distributed systems.

Communication among different nodes of such a data transmission system takes place increasingly via a bus system. This communication traffic on the bus system, access mechanisms, and receiving mechanisms, as well as error processing, are regulated via a protocol. One known protocol is, for example, the FlexRay protocol, currently based on the FlexRay protocol specification v. 2.1. FlexRay is a high-speed, deterministic, and error-tolerant bus system, in particular for use in motor vehicles. The FlexRay protocol operates according to the time-division multiple-access (TDMA) principle, in which the nodes or the messages to be transmitted are assigned fixed time slots in which they have exclusive access to the communication link. The time slots are repeated in a pre-established cycle, so that the point in time at which a message is transmitted over the bus may be accurately predicted, and bus access takes place deterministically.

In order to utilize the bandwidth for message transmission on the bus system optimally, FlexRay subdivides the cycle into a static and a dynamic part, i.e., a static and a dynamic segment. The fixed time slots are located in the static part at the beginning of a bus cycle. In the dynamic part, the time slots are dynamically defined. Exclusive bus access is enabled only for a short time, for the duration of at least one so-called minislot. Only if a bus access occurs within a minislot is the time slot extended for the time needed for the access. The bandwidth is thus only used if it is actually needed. FlexRay communicates via one or two physically separated lines at a data rate of 10 Mbit/s maximum. Of course, FlexRay may also be operated at lower data rates. The two channels correspond to the physical layer, in particular of the so-called OSI (Open System Architecture) layer model. They are used for the redundant and therefore error-tolerant transmission of messages, but may also transmit different messages, whereby the data rate might be doubled. It is also conceivable that the signal transmitted via the link lines results from the difference of the signals transmitted over the two lines. The physical layer is designed in such a way that it makes both electrical and optical transmission of the signal(s) via the line(s) or transmission in other ways possible.

In order to implement synchronous functions and to optimize the bandwidth via small intervals between two messages, the nodes in the communication network need a common time base, known as global time. For the synchronization of local clocks of the nodes, synchronization messages are transmitted in the static part of the cycle, the local time being corrected with the aid of a special algorithm according to the FlexRay specification in such a way that all local clocks run synchronously with a global clock.

The encoded data rate delivers acceptable image quality for TV pictures for screen sizes up to 40″ (101.6 cm) diagonal. However, considerably smaller screens are used in automobiles, where typical sizes are up to 10.4″ (26.42 cm). Coding artifacts disturb the human eye less on smaller screen sizes than on large screens. Therefore, for automotive applications, the data rate may be further reduced without image interference occurring that is perceptible by the human eye. A data rate of 2 Mbit/s is realistic for video applications. Video sources in the automobile, however, have higher data rates than the actually needed 2 Mbit/s. A DVD data source has peak data rates of up to 9 Mbit/s; digital land TV is transmitted at 4 Mbit/s. The semiconductor industry delivers high-performance chip sets which recode digital video data for transmission in vehicles at lower data rates. The requirements for the bus system in the vehicle are thus reduced. Table 1 shows typical data rates for multimedia applications.

TABLE 1
Typical data rates for multimedia applications.

| | Data rate | | Data rate | |
|---|---|---|---|---|
| Application | (unencoded) | | (encoded) | |
| TV picture (720 × 576 | 166 | Mbit/s | 4 | Mbit/s (MPEG-2) |
| pixels) | | | | |
| Videoconference (288 × | 30 | Mbit/s | 1.5 | Mbit/s (MPEG-1) |
| 360 pixels) | | | | |
| Audio-CD (stereo) | 1.412 | Mbit/s | 192 | kbit/s (MP3) |

### SUMMARY OF THE INVENTION

Based on the above-described related art, an object of the exemplary embodiments and/or exemplary methods of the present invention is to reduce the number of different bus systems in a motor vehicle.

To achieve this object, it is suggested, based on the method of the type described above, that the MPEG multimedia data be transmitted over a FlexRay communication system according to the FlexRay protocol.

It is therefore proposed according to the exemplary embodiments and/or exemplary methods of the present invention that the FlexRay protocol and thus FlexRay protocol modules having the specific FlexRay driver modules be used for transmitting MPEG data streams. FlexRay protocol modules include a FlexRay communication controller (CC), a FlexRay bus driver (BD), and optionally a FlexRay bus guardian (BG). FlexRay may transmit payload data of 0 to 254 bytes in one data frame. The smaller the amount of payload data, the lower the protocol efficiency. Since the MPEG data packets have a frame length of 188 bytes, FlexRay is ideally suited for transmitting multimedia data in the MPEG format. Transmission of an MPEG data stream via a FlexRay communication system is also referred to as “tunneling” of MPEG data packets over FlexRay data frames.

The use of the FlexRay protocol in combination with a practical communication schedule for transmitting MPEG data streams, for example, when playing back a DVD or when using digital TV (DVB), has the advantage that a FlexRay bus system, which is present in a motor vehicle anyway, or at least will be in the future, may also be used for transmitting multimedia data between nodes from the consumer electronics area. No special direct wiring or an additional bus system for transmitting multimedia data between the multimedia nodes is therefore needed. Contrary to the known MOST bus systems, the FlexRay bus system is much better suited for transmitting multimedia data in MPEG format. This is utilized in the exemplary embodiments and/or exemplary methods of the present invention. According to the exemplary embodiments and/or exemplary methods of the present invention, the number of different bus systems in a motor vehicle is thus reduced, resulting in substantial weight and cost reduction. Furthermore, the exemplary embodiments and/or exemplary methods of the present invention allows MPEG multimedia data to be transmitted much more efficiently, thus saving resources.

MPEG2 packets or MPEG2 data frames may be tunneled via FlexRay data frames, i.e., copied in a 1:1 ratio into the payload data segment of the FlexRay data frame and transmitted via at least one communication link of the FlexRay communication system. In the receiving multimedia nodes, the data contents of the FlexRay data frames and thus also the MPEG2 packets are unpacked from the payload data area of the FlexRay data frame and the multimedia data are supplied for MPEG2 decoding. The usual output of the multimedia data to the user then follows, in particular acoustic and/or visual output via loudspeakers and/or screens.

According to another approach for achieving the object of the exemplary embodiments and/or exemplary methods of the present invention, it is proposed, based on a communication system for transmitting multimedia data in MPEG format of the above-mentioned type, that the communication system be designed as a FlexRay communication system. It is also proposed, for the first time, according to the exemplary embodiments and/or exemplary methods of the present invention, that MPEG multimedia data be transmitted in a FlexRay communication system according to the FlexRay protocol, for example, according to the current FlexRay specification v. 2.1.

According to another approach for achieving the object of the exemplary embodiments and/or exemplary methods of the present invention, it is proposed, based on a communication system for transmitting multimedia data in MPEG format of the above-mentioned type, that the multimedia node have a FlexRay communication controller for transmitting the MPEG multimedia data according to the FlexRay protocol. In the transmitting multimedia nodes, the FlexRay communication controller is used for embedding MPEG data frames into FlexRay data frames provided for the transmission. The FlexRay data frames are then applied by a bus driver to at least one communication link of the FlexRay communication system for data transmission. In a receiving multimedia node, the FlexRay communication controller is used for removing MPEG data frames from the received FlexRay data frames.

Finally, for achieving the object of the exemplary embodiments and/or exemplary methods of the present invention based on a gateway for connecting a multimedia node to at least one communication link of a communication system of the above-mentioned type, it is proposed that the gateway has an arrangement for transmitting multimedia data in MPEG format to at least one other node of the communication system via the at least one communication link, the arrangement being at least one FlexRay communication controller for transmitting MPEG multimedia data according to the FlexRay protocol. Such a gateway may be connected between conventional standard multimedia nodes and the at least one communication link of the FlexRay communication system. Thanks to the gateway, the MPEG multimedia data packets provided by a multimedia source are situated in the FlexRay data frame, i.e., in a payload data segment of the data frame, in such a way that they may be transmitted according to the FlexRay protocol via the communication system.

An exemplary embodiment of the present invention is elucidated below in greater detail with reference to the figures. Further features, advantages, and embodiments of the present invention are presented in the figures and their corresponding description.

### BRIEF DESCRIPTION OF THE DRAWINGS

FIG. 1 shows a communication system for transmitting MPEG multimedia data according to the FlexRay protocol.

FIG. 2 shows the tunneling of MPEG2 data frames in a payload segment of a FlexRay data frame.

FIG. 3 shows the structure of a FlexRay data frame.

FIG. 4 shows the structure of an MPEG2 data frame.

FIG. 5 shows an MPEG data stream including a plurality of consecutive MPEG data frames.

FIG. 6 shows A MOST frame format.

### DETAILED DESCRIPTION

It is known from the related art to transmit multimedia data, in particular in the MPEG2 format, from a multimedia source to receiving multimedia nodes, for example, loudspeakers and/or screens, via a communication link of a MOST (Media-Oriented Systems Transport) communication system. The MOST frame format is shown in FIG. 6. The MOST bus supports data rates from 5.76 Mbit/s to 24 Mbit/s. A parameter set enabling 21.17 Mbit/s has been established. The MOST standardization goes back to an initiative from 1997, when the only digital data source commonly used was the audio CD. Therefore, designing the MOST data structure in such a way that CD audio channels could be optimally transmitted using the MOST data transmission system was the logical thing to do. A block of the MOST frame structure has 16 data frames. Each frame must contain synchronous data; it may, however, also additionally contain asynchronous data. A maximum of 60 bytes per frame may be transmitted to synchronous data which include audio and video streams in particular. At a frame repetition rate of 41.1 kHz, which corresponds to the CD sampling rate, a data transmission rate over a MOST communication system that is compatible with the audio CD results (when using three of the maximum of 16 available logic channels). While this MOST frame format is well-suited for CD audio, it has only limited suitability for modern video data streams, in particular for multimedia data in MPEG format.

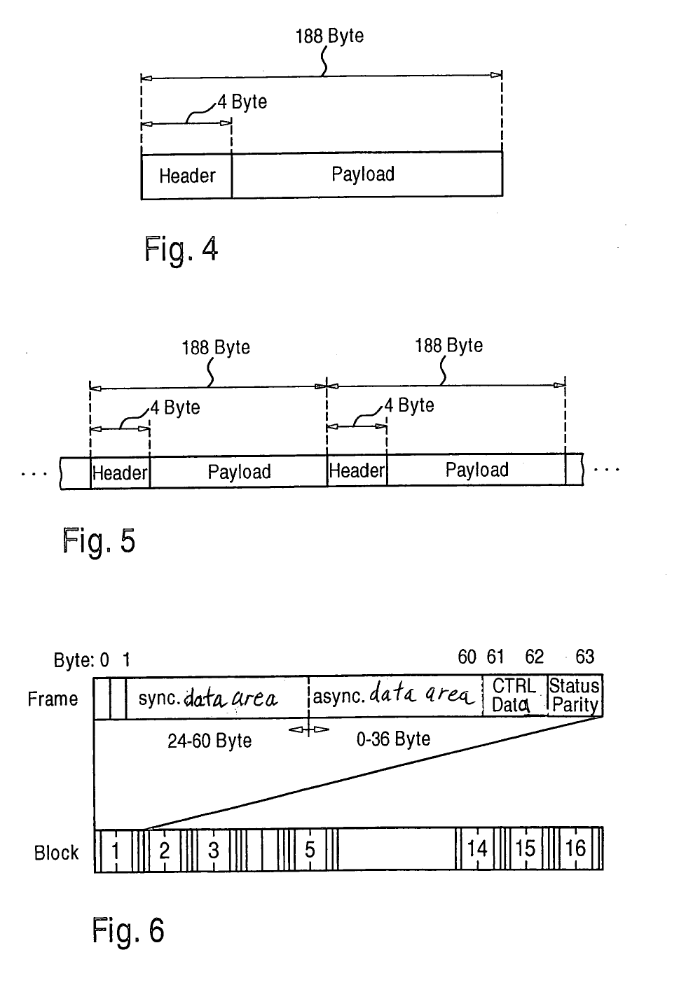

A TV picture having a resolution of 720×576 pixels requires, for example, a data transmission rate of 166 Mbit/s and may be compressed to 4 Mbit/s with the aid of MPEG2 encoding. The MPEG2 data are composed of 188-byte packets or data frames having 4-byte headers and a 184-byte payload, i.e., video data. Such a data frame is depicted in FIG. 4 as an example. An MPEG2 data stream includes a plurality of such consecutive MPEG2 data frames (see FIG. 5).

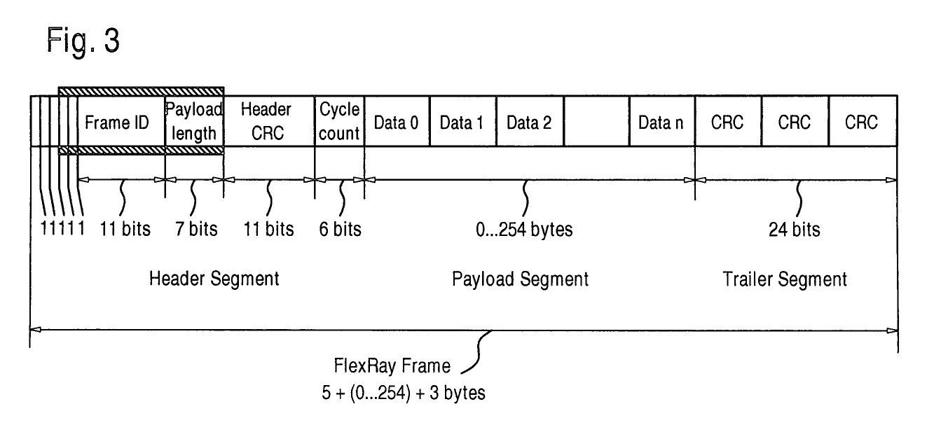

In particular for transmitting safety-relevant and safety-critical data, a FlexRay communication system is known from the related art. When transmitting data according to the FlexRay protocol, for example, according to FlexRay specification v. 2.1, the data are transmitted cyclically. A repeating communication cycle includes a static segment and a dynamic segment, as well as further information (for example, symbol window (SW), network idle time (NT)). Time slots of defined, fixedly specified length assigned to the different nodes of the communication system are provided in the static segment. In the dynamic part, the time slots are dynamically defined. Exclusive access to the FlexRay data bus is enabled only for a short time, for the duration of at least one so-called minislot. Only if a bus access occurs within a minislot is the time slot extended to the time needed for the access. Bandwidth is thus used in the dynamic segment only when it is actually needed. The fixed time slots and the dynamic time slots have the same structure in principle. The time slots include an idle time at the beginning and at the end of the time slot and a static or dynamic data frame between them. Such a FlexRay data frame is shown in detail in FIG. 3 as an example.

A header segment having a total length of 40 bits is provided at the beginning of the data frame. The header segment includes a bit (reserved bit) which is reserved for future extensions. It is followed by another bit (payload preamble indicator) which indicates the existence of vector information in the payload segment of the data frame. It is followed by another bit (null frame indicator), which indicates whether the data frame in the payload segment is equal to zero. Another bit (sync frame indicator) indicates the existence of a synchronization data frame. A last bit (start-up frame indicator) indicates whether or not the node transmitting a data frame is the start-up node. This is followed by an identification of the 11-bit long frame ID, which is assigned to each node of the communication system (valid range: 1 to 2047). This is followed by 7 bits specifying the data length of the payload segment. Following are 11 bits (header CRC (cyclic redundancy check)), which specify the ascertained CRC values of the “sync frame indicator,” “start-up frame indicator,” “frame-ID,” and “length” bits which have been calculated by a host computer of the transmitting node. Provided at the end of the header segment are 6 bits (cycle count) which count the cycle of the node which transmits the data frame during the data transmission time.

After the header segment a payload segment follows which has a length of 0 to 254 bytes. The size of the payload segment may be freely selected prior to the actual data transmission as a function of the amount of data to be transmitted and the data transmission rate. A 24-bit long trailer segment which includes calculated CRC values is provided at the end of the data frame. A FlexRay data frame thus has a length of 5 bytes+0 to 254 bytes+3 bytes=8 to 262 bytes.

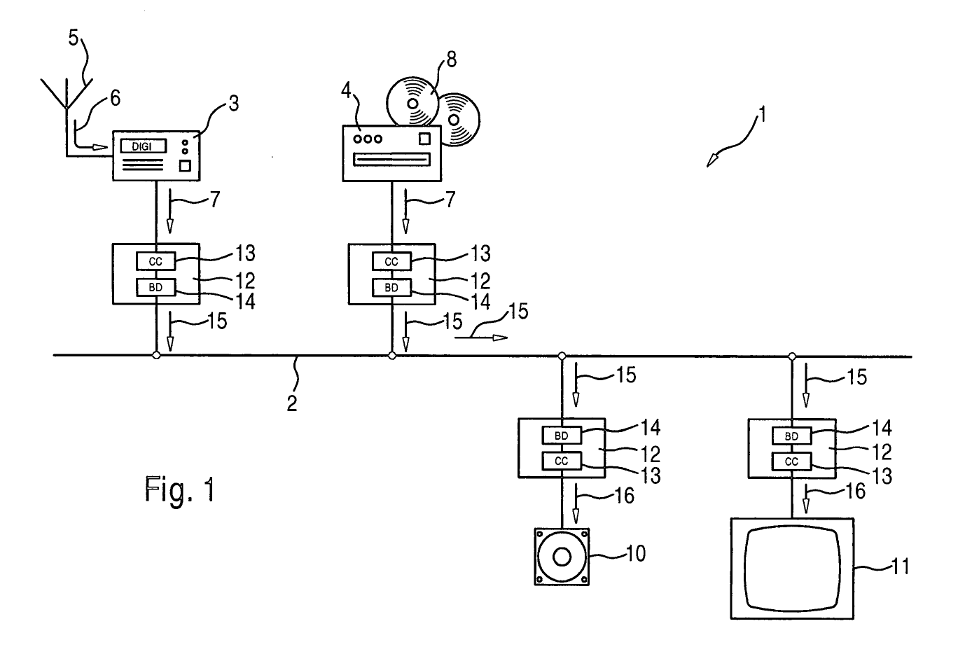

In FIG. 1, a communication system according to the present invention overall is labeled with reference numeral 1. The communication system includes at least one communication link 2 referred to as a physical layer. Communication link 2 may be designed as an electrically conductive line, an optical waveguide, or even as a wireless transmission path. A plurality of multimedia nodes is connected to the at least one communication link 2. A digital TV signal receiver 3 and a DVD player 4 are depicted in the exemplary embodiment of FIG. 1 as nodes. Receiver 3 receives digital TV signals 6 received via an antenna 5 and converts them into multimedia data 7 in MPEG2 format. DVD player 4 reads audio and/or video data from a DVD 8. If the audio and/or video data are not yet in MPEG2 format, DVD player 4 converts these data into the MPEG2 format. Otherwise the audio and/or video data that have been read may be directly relayed as MPEG2 data 9.

In addition, in communication system 1 depicted in FIG. 1, further nodes in the form of multimedia receivers such as a loudspeaker 10 and a screen 11 are connected to communication link 2.

Nodes 3, 4, 10, 11 are conventional MPEG2 sources or MPEG2 receivers. For nodes 3, 4, 10, 11 to be able to transmit MPEG2 data via communication link 2 according to the FlexRay protocol, nodes 3, 4, 10, 11 are connected to the at least one communication link 2 not directly, but via gateways 12. Gateways 12 are used for inserting the multimedia data received from multimedia sources 3, 4 in MPEG2 format into the payload segment of the FlexRay data frame (see FIG. 3). This is done in particular by one of the FlexRay communication controllers (CC) 13 provided in the gateways. The FlexRay data frames containing the MPEG2 packets are then relayed to a bus driver (BD) 14, which is also provided in gateways 12, and applied by the latter to communication link 2 for data transmission. The arrows having reference numeral 15 in FIG. 1 show the transmission of the FlexRay data frames via the at least one communication link 2 to receiving nodes 10, 11.

Receiving nodes 10, 11 are also connected to communication link 2 via gateways 12, which also include a FlexRay communication controller 13 and a bus driver 14. Incoming FlexRay data frames 15 are received by bus drivers 14 of gateways 12 associated with receiving nodes 10, 11 and relayed to FlexRay communication controller 13 for decoding, where the MPEG2 data packets are removed from the payload segment of FlexRay data frame 15. MPEG2 data packets 16 are relayed to receiving nodes 10, 11 for further processing. Further processing of the MPEG2 data packets includes decoding and/or output of the contents of the data packets to a user, in particular in acoustic form via loudspeaker 10 and/or in visual form via screen 11. Of course, loudspeaker 10 and screen 11 may also be connected to a shared gateway 12 in such a way that the audio and video data contained in the MPEG2 data stream may be output via loudspeaker 10 and screen 11. The MPEG2 data packets may be decoded either in gateway 12 or in receiving nodes 10, 11.

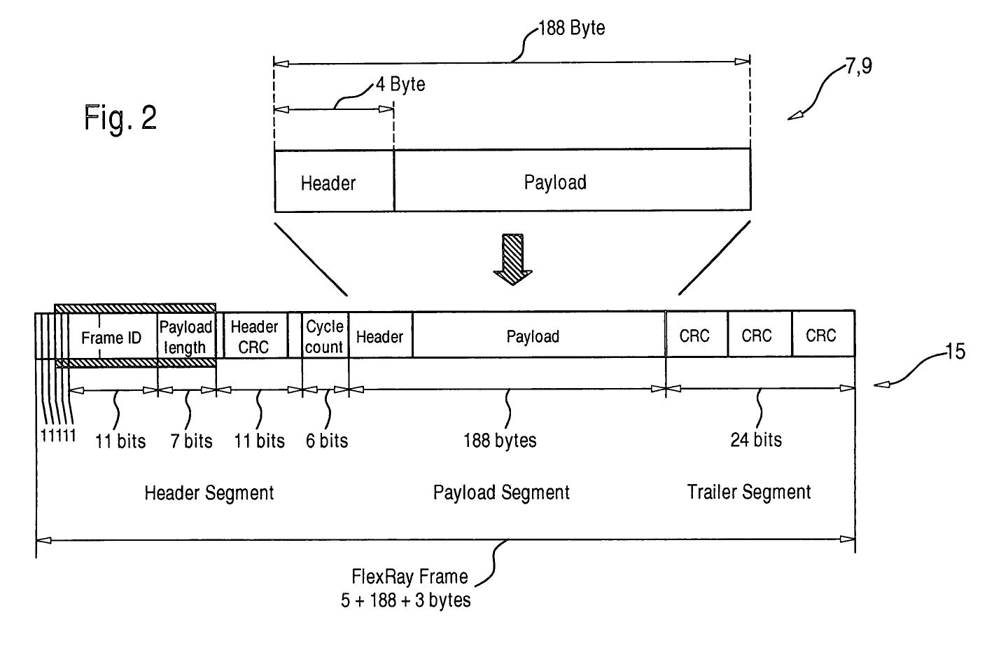

FIG. 2 shows how a 188 byte long MPEG2 data frame is inserted into the payload segment of a FlexRay data frame. For a particularly efficient and effective transmission, the size of the payload segment is also established at 188 bytes, equal to the size of the MPEG2 data frame. The repetition rate of the FlexRay data transmission cycle is selected in such a way that the MPEG2 data stream having the continuously incoming MPEG2 data frames therein may be transmitted so rapidly that a user of receiving nodes 10, 11 is unable to perceive any delays or jitter due to the data transmission via communication link 2. It is conceivable that not only one time slot, but a plurality of time slots and thus also a plurality of FlexRay data frames is provided within a FlexRay data transmission cycle for the transmission of the incoming MPEG2 data packets. Furthermore, it would be conceivable to provide transmitting nodes 3, 4 and optionally also receiving nodes 10, 11 with buffer memories for buffering MPEG2 data packets 7, 9 or 16 to be transmitted or received. Of course, gateways 12 may also be integrated into associated nodes 3, 4, 10, 11 in such a way that entirely novel multimedia nodes are obtained, which process MPEG2 multimedia data and are able to condition these data for data transmission via a FlexRay communication system 1. Optionally, a so-called bus guardian may also be provided in gateways 12, which monitors the function of bus driver 14 to prevent interference by a “bubbling idiot.”

A TV picture having a resolution of 720×576 pixels requires a data transmission rate of 166 Mbit/s and may be compressed to 4 Mbit/s with the aid of MPEG2 encoding. The MPEG2 data are composed of 188-byte packets or data frames having 4-byte headers and 184-byte useful data, i.e., video data (see FIG. 4). These packets are copied, i.e., converted, 1:1 into the payload segment of a FlexRay data frame 15. The payload segment may have a size equal to that of the MPEG2 packets, in particular a size of 188 bytes. This also means that all MPEG2 control data are preserved and the FlexRay data frame structure is only used as a “tunnel” for the MPEG2 data stream.

The following exemplary assumptions are made for the parameters for transmission according to the FlexRay protocol:

The cycle time (repetition rate of the data frames) is 5 ms, composed of a static segment of 3 ms and a dynamic segment of 2 ms. The static data frames have a size of 5+188+3=196 bytes. The dynamic data frames have a maximum size of 254 bytes. Approximately 10 static time slots and approximately 6 dynamic time slots having 188 bytes are thus available, frame overhead and precision consideration being taken into account in principle.

To transport the encoded data frames for an MPEG2 data stream, the data volume must be recalculated to the 5 ms FlexRay communication cycle and the number of FlexRay data frames must be determined. In the standard configuration, a FlexRay data frame is assigned to a time slot and transmitted. Therefore, to transmit 4 Mbit/s, 20 kbits must be transported for each communication cycle (5 ms), i.e., 2500 bytes per communication cycle. For a FlexRay configuration of 188 bytes per FlexRay data frame, 13.3 data frames result for each communication cycle (5 ms). All static time slots and four dynamic time slots are thus utilized for this transmission of the MPEG2 data stream.

The bandwidth of the data transmission may be optimized in different ways. On the one hand, it is conceivable to use the FlexRay channels for splitting the bus load into 2×10 Mbit/s. On the other hand, it is conceivable to reduce the transmitted image information and still preserve an acceptable image quality for screens in the motor vehicle.

The first optimization option is based on the FlexRay protocol permitting the transmission of messages on two separate channels for safety considerations. These channels may be used redundantly, but also in parallel, i.e., FlexRay also permits, in principle, the transmission of two different messages on the two channels. These different messages may also be received independently of each other. This option may be used for doubling the bandwidth. The above-mentioned data rates may thus be doubled or the number of required time slots may be halved. From the above example, a reduction to 6.7 data frames per communication cycle (5 ms) results.

The second optimization option is based on the encoded data rate delivering acceptable image quality for TV pictures for screen sizes up to 40″ (101.6 cm) diagonal. However, considerably smaller screens are used in automobiles, where typical sizes are up to 10.4″ (26.42 cm). Due to the encoding of audio and/or video data in the MPEG2 format, coding artifact phenomena and interference disturb the human eye less on smaller screen sizes than on large screens. Therefore, for automotive applications, the data rate may be further reduced without perceptible image interference occurring. A data rate of 2 Mbit/s is realistic for audio and video applications. In the above-mentioned example, the number of FlexRay data frames may thus be reduced by one-half. Together with the measures according to the first optimization procedure, the load is reduced to 3.3 FlexRay data frames per communication cycle (5 ms).

The most important features and advantages of the exemplary embodiments and/or exemplary methods of the present invention are summarized below:
1:1 conversion of MPEG2 data packets into FlexRay data frames having a 188 byte long payload segment.
Doubling of the FlexRay bandwidth by separate operation of the two available channels (channel A and channel B).
Reduction of the MPEG2 data stream via data reduction of image data prior to transmission via the FlexRay communication system due to reduced requirements for display on automotive screens.
The messages (data frames) from the area of the multimedia applications are integrated into the system electronics area. Simplification of the network topology within the vehicle results.
The messages (data frames) from the area of the multimedia applications are integrated into the FlexRay backbone, which also results in simplification of the network topology.
The FlexRay message catalog is fully adapted (configured) to the needs of the multimedia applications, in particular the MPEG2 data format, and thus the highest performance is achieved for a multimedia network.
Due to the reconfiguration of multimedia nodes 3, 4, 10, 11 to FlexRay communication, additional FlexRay protocol modules (communication controllers) and/or FlexRay driver modules (bus drivers) are needed. The result is additional components with the associated mass production effect (lower unit price) and reliable and sturdy manufacturing of the modules.
The additional mass production effect results in reduced component costs. The reconfiguration effort is compensated by the long-term mass production effect or is negligible compared to the latter.

1-16. (canceled)

17. A method for transmitting multimedia data, the method comprising:
transmitting MPEG (Moving Picture Experts Group) format multimedia data between multimedia nodes of a communication system via at least one communication link of the communication system;
wherein the MPEG multimedia data are transmitted via a FlexRay communication system according to the FlexRay protocol.

18. The method of claim 17, wherein, in a transmitting multimedia node, MPEG data frames are embedded into FlexRay data frames that are transmitted, and wherein, in a receiving multimedia node, the MPEG data frames are removed from received FlexRay data frames for further processing.

19. The method of claim 18, wherein a size of payload segments of the FlexRay data frames are adjusted to a size of the MPEG data frames.

20. The method of claim 19, wherein the size of the payload segments is selected as an integer multiple of the size of the MPEG data frames.

21. The method of claim 20, wherein the size of the payload segments is selected to be the same as that of the MPEG data frame.

22. The method of claim 17, wherein the MPEG multimedia data are in the MPEG2 format.

23. The method of claim 18, wherein the MPEG data are decoded during further processing.

24. The method of claim 18, wherein the MPEG data are at least one of acoustically output and visually output to a user of the receiving multimedia node within the scope of further processing.

25. A communication system for transmitting multimedia data in MPEG (Moving Picture Experts Group) format, comprising:
multiple multimedia nodes;
at least one communication link between the multimedia nodes;
wherein the communication system includes a FlexRay communication system.

26. The communication system of claim 25, wherein the FlexRay data frames are for transmitting MPEG data frames, and wherein a size of the payload segments of the FlexRay data frames is adjusted to a size of the MPEG data frames.

27. A multimedia node system of a communication system, comprising:
multimedia nodes, each multimedia node including an arrangement for transmitting multimedia data in MPEG format to at least one other multimedia node of the communication system via at least one communication link of the communication system;
wherein the arrangement includes at least one FlexRay communication controller for transmitting the MPEG multimedia data according to the FlexRay protocol.

28. The multimedia node system of claim 27, wherein the FlexRay communication controller is for embedding MPEG data frames into the FlexRay data frames provided for transmission.

29. The multimedia node system of claim 27, wherein the FlexRay communication controller is for removing MPEG data frames from the received FlexRay data frames.

30. The multimedia node system of claim 28, wherein in the FlexRay communication controller, a size of payload segments of the FlexRay data frames is adjusted to a size of the MPEG data frames.

31. A gateway for connecting a multimedia node to at least one communication link of a communication system, comprising:
at least one FlexRay communication controller; and
a transmitting arrangement to transmit multimedia data in MPEG format as MPEG multimedia data to at least one other node of the communication system via the at least one communication link, wherein the transmitting arrangement includes the at least one FlexRay communication controller for transmitting the MPEG multimedia data according to the FlexRay protocol.

32. The gateway of claim 31, wherein in the FlexRay communication controller, a size of a payload segment of the FlexRay data frames is adjusted to the size of the MPEG data frames.
